(19) United States
(12) Patent Application Publication
(10) Pub. No.: US 2023/0387764 A1
(43) Pub. Date: Nov. 30, 2023

(54) METHOD AND DEVICE FOR JOINING A REINFORCEMENT SLEEVE ONTO A ROTOR OF AN ELECTRIC MOTOR

(71) Applicant: SCHUNK KOHLENSTOFFTECHNIK GMBH, Heuchelheim (DE)

(72) Inventor: Volker BIER, Fronhausen (DE)

(73) Assignee: SCHUNK KOHLENSTOFFTECHNIK GMBH, Heuchelheim (DE)

(21) Appl. No.: 18/249,613

(22) PCT Filed: Oct. 28, 2020
(86) PCT No.: PCT/EP2020/080224

§ 371 Date: Apr. 19, 2023

(51) Int. Cl. H02K 15/02; H02K 1/28

(52) U.S. Cl. CPC H02K 15/02; H02K 1/28; H02K 2215/00

(57) ABSTRACT

A method and a device for joining a reinforcement sleeve onto a rotor of an electric motor. The method includes providing the reinforcement sleeve and the rotor, the reinforcement sleeve has a cylindrical inner periphery which is undersized with respect to a cylindrical outer periphery of the rotor; attaching at least two vacuum cups onto an outer lateral surface of the reinforcement sleeve, such that the vacuum cups adhere to the outer lateral surface of the reinforcement sleeve in a reversibly detachable manner on account of a vacuum generated between the vacuum cup and the outer lateral surface; and joining the reinforcement sleeve onto the rotor, in that the rotor is pressed into the reinforcement sleeve in a pressing direction.

### FIELD

The present invention relates to a method and a device for joining a reinforcement sleeve onto a rotor of an electric motor.

### BACKGROUND

Rotors of electric motors may be subjected to significant centrifugal forces at high speeds. In particular rotors, which are made up of a plurality of components, therefore have to be designed so as to be very stable.

For example, rotors of particular electric motors may comprise magnets attached thereto. For example, in the case of a rotor, a plurality of magnets may typically be held on a shaft-like carrier body, and in this case for example be received in receiving pockets of the carrier body, and/or be attached to the carrier body in a force-fitting, form-fitting and/or integral manner. In this case, it is necessary in particular to prevent the magnets and/or other rotor components from detaching at high speeds, on account of centrifugal forces.

Electric motors have been developed in which the rotor is stabilized by a reinforcement. The reinforcement may be designed in particular as a sleeve and may surround at least portions of the rotor in an annular manner A reinforcement sleeve of this kind may also be referred to as a bandage. The reinforcement sleeve may be formed of a mechanically highly resilient material such as a carbon fiber reinforced plastics material (CFRP).

Conventionally, reinforcement sleeves are typically pressed or shrunk onto rotors of electric motors. The inner periphery of the generally cylindrical reinforcement sleeve is undersized to a certain extent with respect to an outer periphery of the rotor, i.e. an inner diameter of the reinforcement sleeve is slightly smaller than an outer diameter of the rotor. During manufacture of the electric motor, the reinforcement sleeve is pressed over the rotor, such that it sits on the rotor in a torque-proof manner, in a press fit. In this case, during the pressing process the inner surface of the reinforcement sleeve is moved over the outer surface of the rotor, in a manner driven by a force acting in the axial direction.

It has been observed that, in the case of manufacture of rotors for electric motors, in particular when joining a reinforcement sleeve onto the rotor, damage to the reinforcement sleeve may occur.

### SUMMARY

There may therefore be a need for a method and for a device for joining a reinforcement sleeve onto a rotor of an electric motor, by means of which in particular damage to the reinforcement sleeve, caused within the context of the joining process, may be prevented.

A first aspect of the invention relates to a method for joining a reinforcement sleeve onto a rotor of an electric motor. The method comprises at least the following steps, preferably in the specified sequence:
providing the reinforcement sleeve and the rotor, wherein the reinforcement sleeve has a cylindrical inner periphery which is undersized with respect to a cylindrical outer periphery of the rotor;
attaching at least two vacuum cups onto an outer lateral surface of the reinforcement sleeve, such that the vacuum cups adhere to the outer lateral surface of the reinforcement sleeve in a reversibly detachable manner on account of a vacuum generated between the vacuum cup and the outer lateral surface; and
joining the reinforcement sleeve onto the rotor, in that the rotor is pressed into the reinforcement sleeve in a pressing direction, wherein forces acting in the pressing direction are transferred from the vacuum cups to the reinforcement sleeve.

A second aspect of the invention relates to a device for joining a reinforcement sleeve onto a rotor of an electric motor, wherein the device is designed to carry out the method according to an embodiment of the first aspect of the invention. In particular, a device is described which comprises a pressing tool and at least two vacuum cups. The pressing tool is designed to displace the rotor and the reinforcement sleeve relative to one another, in an opposing pressing direction, during a joining process in which the reinforcement sleeve is joined onto the rotor. The vacuum cups are in each case designed to generate a vacuum between the vacuum cup and an outer lateral surface of the reinforcement sleeve, and to thereby cause the vacuum cup to adhere to the outer lateral surface of the reinforcement sleeve in a reversibly detachable manner. Furthermore, the pressing tool and/or the vacuum cups are designed such that, during the joining process, forces acting in the pressing direction are transferred from the vacuum cups to the sleeve.

Without in any way limiting the scope of the invention, ideas and possible features regarding embodiments of the invention may be considered inter alia as being based on the concepts and findings described below.

As already noted at the outset, it has been observed that, in a case of conventionally performed joining of a reinforcement sleeve onto a rotor, damage may be caused on the reinforcement sleeve. Conventionally, the reinforcement sleeve is pressed onto the rotor, in that a high pressure is exerted on a first end face of the reinforcement sleeve by means of a pressing tool, in particular a press ram. In order to be able to press the reinforcement sleeve over the rotor in the axial direction, very high contact pressures must be exerted on the first end face of the reinforcement sleeve in the process. In this case, an axial pressing force is typically dependent on the key structural factors (I) radial undersize and (II) length of the sleeve in rotor engagement. If the pressing forces are too great, damage to the reinforcement sleeve at the point of engagement of the press ram on the end face of the reinforcement sleeve may occur.

In order to alleviate the observed problem, it is proposed to modify the joining process in a suitable manner, such that it is no longer the case that the entirety of the forces required for pressing on the reinforcement sleeve are exerted onto the first end face of the reinforcement sleeve. For this purpose, vacuum cups are provided, by means of which at least a portion of the forces to be exerted on the reinforcement sleeve may be exerted on a lateral surface of the reinforcement sleeve, instead of on the end face. In this case, the vacuum cups are designed such that they may be placed against the outer lateral surface of the reinforcement sleeve and may generate a vacuum, i.e. a significant negative pressure, between them and the outer lateral surface. On account of this vacuum, the vacuum cup adheres to the lateral surface of the reinforcement sleeve, this mechanical connection being able to be released by venting and thus removing the vacuum. By means of the vacuum cups attached to the lateral surface of the reinforcement sleeve in this way, forces may then be transferred to the reinforcement sleeve, which forces assist the joining of the reinforcement sleeve onto the rotor, in the pressing direction. The forces to be exerted on the first end face of the reinforcement sleeve during joining may thus be reduced, and therefore a risk of damage to the first end face may be reduced.

Typically, a reinforcement sleeve, which is intended to serve as bandaging for a rotor and is intended to stabilize said rotor with respect to centrifugal forces acting on it and its components, is designed and dimensioned in such a way that the inner periphery thereof is undersized to a certain extent, with respect to the outer periphery of the rotor, before the reinforcement sleeve is joined onto the rotor. Such an undersize means that the inner periphery of the reinforcement sleeve is slightly smaller than the outer periphery of the rotor. In this case, the inner periphery of the reinforcement sleeve and the outer periphery of the rotor are generally cylindrical, in particular circular cylindrical. In the case of a circular cylindrical design, the undersize thus means that the radius or diameter at the inner periphery of the reinforcement sleeve is slightly smaller, i.e. depending on the dimensions of the stated components for example 0.02 mm to 0.1 mm smaller, than the radius or diameter, respectively, on the outer periphery of the rotor. On account of this undersize, the reinforcement sleeve cannot be pushed onto the rotor in a largely force-free manner, but rather has to be pressed onto the rotor with significant forces acting in the axial direction. Furthermore, the press fit brought about in the process results in the reinforcement sleeve being fixed to the rotor in a stable and torque-proof manner. In this case, the undersize is generally selected such that the reinforcement sleeve is always held on the rotor by a sufficient press fit, even in the case of thermally induced dimensional changes of the rotor and/or of the reinforcement sleeve, within a predetermined operating temperature range. In other words, the undersize should be selected so as to be sufficiently large that, even in the case, for example, of the lowest possible operating temperatures, a thermally induced shrinkage of the diameter of the rotor does not lead to release of the press fit between the rotor and the reinforcement.

According to one embodiment, the reinforcement sleeve has a wall thickness of less than 2 mm, preferably less than 1 mm or even less than 0.5 mm. For example, even reinforcement sleeves having a wall thickness of just 0.3 mm may serve as a sufficiently stable bandage for some rotors.

It has been observed that, in particular reinforcement sleeves having low wall thicknesses, may react sensitively to contact pressures which are exerted on one of their end faces. On the one hand, the end face of a thin-walled reinforcement sleeve offers little surface for being able to introduce forces, acting in the axial direction, into the reinforcement sleeve, such that very high pressures have to act. On the other hand, reinforcement sleeves having a paper-thin wall have only low dimensional stability in the axial direction, such that they tend to deform or even bend in the case of axial pressure or thrust. In particular for this reason, hitherto reinforcement sleeves having relatively thick walls have been used for bandaging rotors. However, such thick-walled reinforcement sleeves increase both an installation space of the ultimately manufactured rotor, and the weight and inertia torque thereof. Furthermore, a thick-walled reinforcement sleeve typically causes an increase in the size of an air gap between the rotor and a stator of the electric motor, which may result in a reduction in efficiency of the electric motor.

By means of the joining method presented herein, very thin-walled reinforcement sleeves may also be joined onto rotors. In this case, due to the sought transmission of force in the pressing direction by means of the vacuum cups previously stuck onto the lateral surface of the reinforcement sleeve, the forces to be exerted on the very narrow end faces of the thin-walled reinforcement sleeve, for the purpose of joining, may be kept sufficiently small or in extreme cases even omitted entirely, such that damage to the sensitive end face may be prevented.

According to one embodiment, the reinforcement sleeve is formed using or consists of fiber-reinforced, in particular carbon fiber-reinforced or glass fiber-reinforced, plastics material.

Reinforcement sleeves made of fiber-reinforced plastics material may be particularly mechanically resilient, and thus, as bandaging, stabilize rotors particularly well with respect to centrifugal forces. In this case, carbon fibers, glass fibers or other fibers, incorporated in the plastics material, may extend in the peripheral direction of the reinforcement sleeve, at least in part, and in this case, on account of their very low elasticity, may hold the rotor together even in the case of very high rotational speeds. Furthermore, for example carbon fiber-reinforced plastics material often has a very low thermal expansion coefficient, in particular a thermal expansion coefficient of close to zero in the radial direction, such that a reinforcement sleeve consisting of this ensures sufficient stabilization of the bandaged rotor, even in the case of high operating temperatures.

However, it has been observed that precisely reinforcement sleeves consisting of carbon fiber-reinforced plastics material may react relatively sensitively to excessive contact pressures acting on their end face.

By way of the joining method presented herein, such contact pressures may be reduced, and thus the reinforcement sleeve may be protected during joining.

The vacuum cups, which are intended to temporarily engage on the outer lateral surface of the reinforcement sleeve by means of a negative pressure generated by said cups, and via which forces acting in the pressing direction, which are intended to assist the joining of the reinforcement sleeve, are intended to be transferred to the lateral surface of the reinforcement sleeve, may be arranged and designed in different manners.

In this case, the vacuum cups should be designed and arranged such that the forces transferred from them to the reinforcement sleeve, acting in the pressing direction, act on the reinforcement sleeve as far as possible exactly in parallel with the pressing direction. Otherwise, forces acting on the reinforcement sleeve obliquely to the pressing direction could result in the reinforcement sleeve being tilted and/or canted during the joining process, as a result of which the joining process could be disrupted.

Accordingly, one-sided action of pressing forces, generated by a single vacuum cup, on the reinforcement sleeve should generally be avoided, since this would result in the reinforcement sleeve being tilted and/or subjected to a torque. Instead, in the proposed joining method and/or the device used for his purpose, at least two vacuum cups should be provided. The two vacuum cups may engage on the outer lateral surface of the reinforcement sleeve from opposing sides. It is also possible for more than two vacuum cups to be provided. In particular, the vacuum cups may be arranged in a mirror-symmetric arrangement, around the outer lateral surface of the reinforcement sleeve. Alternatively or in addition, the vacuum cups may be arranged around the reinforcement sleeve, at equal spacings along the periphery. In this case, two or more vacuum cups may be designed as mutually separate components, which may be attached to the lateral surface of the reinforcement sleeve from opposing sides, for example. Alternatively, it is also conceivable to integrate two or more vacuum cups in a common component, such that they may for example be displaced and/or acted on by a vacuum together.

Furthermore, the vacuum cups may be designed in different ways in structural and/or functional terms. In particular, in this case the vacuum cups may be adapted to properties, in particular to a geometry, of the reinforcement sleeve, in order to be able to enter as strong as possible an adhesive connection therewith, by means of generation of the vacuum.

For example, according to one embodiment the vacuum cups may have a contour complementary to the outer lateral surface of the reinforcement sleeve, on a side facing the outer lateral surface of the reinforcement sleeve.

In other words, the vacuum cups may have a surface, on a side which faces the reinforcement sleeve during the joining method and which is intended to adhere to the lateral surface of the reinforcement sleeve, which is of a shape that is substantially complementary to the shape of the lateral surface. In particular, said surface of a vacuum cup may form a segment of a cylinder surface. In this case, said surface may have substantially a radius of curvature that is substantially the same as the radius of curvature of the lateral surface of the reinforcement sleeve. In this connection, “substantially” may include deviations which are irrelevant for the function of the vacuum cup upon adhesion to the reinforcement sleeve. For example, deviations of up to 20% or at least of up to 10%, based on the radii of curvature, may be acceptable.

Since the contour of the vacuum cup is complementary to that of the lateral surface of the reinforcement sleeve, the corresponding side of the vacuum cup may be applied as closely and tightly as possible to the lateral surface of the reinforcement sleeve. As a result, the vacuum to be generated between the vacuum cup and the lateral surface of the reinforcement sleeve may be generated efficiently and preferably without substantial leaks. Ultimately, as a result the vacuum cup may be fixed to the reinforcement sleeve with a higher suction force, and thus high contact forces may also be transferred to the reinforcement sleeve, in the pressing direction.

According to one embodiment the vacuum cups may have a contour in the shape of an annular segment, on a side facing the outer lateral surface of the reinforcement sleeve.

In this case, a contour in the shape of an annular segment may be understood to mean that each of the two or more vacuum cups extends along a portion of the lateral surface of the reinforcement sleeve, such that the sum of all vacuum cups extends in an annular manner substantially along the entire periphery of the lateral surface of the reinforcement sleeve. In this case, the vacuum cups may contact the lateral surface of the reinforcement sleeve along a significant portion (e.g. >20%), preferably along the majority (i.e. >50%), particularly preferably along more than 70% or more than 90%, of the periphery of the lateral surface, and in the process adhere to the lateral surface. In this case, each individual vacuum cup may rest against the lateral surface of the reinforcement sleeve by means of a surface that is substantially in the shape of a cylinder segment. In this case, the larger the number of vacuum cups, the smaller the angle section of a contact surface covered by a single vacuum cup may be. In the case of just two vacuum cups, these may for example extend in each case around the periphery of the lateral surface of the reinforcement sleeve over up to 180°, and a contact surface may substantially correspond to half a cylinder surface.

According to one embodiment the vacuum cups may have a friction-enhancing surface, on a side facing the reinforcement sleeve.

In this case, a “friction-enhancing surface” may be understood to mean a surface which has been specially modified with respect to its material properties and/or its surface structure, in order that a friction, with respect to a mating surface on which the surface rests, is as high as possible.

For example, in the present case, the friction-enhancing surface may be formed of or coated with a material which has a high coefficient of friction with respect to the material of the surface of the reinforcement sleeve that is to be contacted. For example, the friction-enhancing surface may be formed of or coated with a flexible and/or resilient material. For example rubber, caoutchouc, latex, or other suitable elastomers may be used as such materials.

Alternatively or in addition, the friction-enhancing surface may have a rough or textured structure, on account of which, upon contact with the lateral surface of the reinforcement sleeve, a friction acting between the two components is increased. For example, the surface of the vacuum cup facing the reinforcement sleeve may be purposely roughened, for example by sand blasting or grinding, or provided with a macroscopic texture, such as a knurling.

On account of the high friction between the vacuum cup and the reinforcement sleeve, brought about by the friction-enhancing surface, particularly high forces may be transferred from the vacuum cups, in the pressing direction, i.e. in a direction which extends substantially in parallel with the lateral surface of the reinforcement sleeve, to the reinforcement sleeve, and thus the joining process may be assisted.

According to one embodiment of the joining method described herein, forces transferred from the vacuum cups to the reinforcement sleeve may be generated in a temporally oscillating manner According to one embodiment of the joining device described herein, said device may comprise an oscillation generator which is designed to generate forces, transferred from the vacuum cups to the reinforcement sleeve, in a temporally oscillating manner.

In other words, the vacuum cups are loaded not only statically, i.e. in a temporally constant manner, in the pressing direction and optionally also transversely to the pressing direction in a suction direction, and thus transfer corresponding static forces to the reinforcement sleeve. Instead, in particular with the aid of the oscillation generator, the forces acting on the vacuum cups may oscillate temporally, i.e. may increase and reduce again in a temporally varying manner.

In this case, forces transferred from the vacuum cups onto the reinforcement sleeve may oscillate in the pressing direction. Alternatively or in addition, the forces transferred from the vacuum cups onto the reinforcement sleeve may oscillate in a direction transverse to the pressing direction, in particular in the suction direction, i.e. orthogonally to the lateral surface of the reinforcement sleeve.

The joining process may be further assisted by the oscillating forces. In particular, the oscillating forces transferred from the vacuum cups onto the reinforcement sleeve may have an assistive effect when the inner periphery of the reinforcement sleeve is intended to be moved over the outer periphery of the rotor. The oscillating forces may in particular help to prevent or immediately resolve a slight canting of the reinforcement sleeve on the rotor.

According to one embodiment, during the joining method a fluid may be introduced between an outer peripheral surface of the rotor and an inner peripheral surface of the reinforcement sleeve.

A fluid introduced in this way may for example reduce friction between the outer peripheral surface of the rotor and the inner peripheral surface of the reinforcement sleeve during the joining procedure, and thus reduce the forces required for joining. The fluid may be a lubricant. The fluid may possibly be selected such that it dries or cures over time, after the joining process, such that a resilient fixing of the reinforcement sleeve to the rotor may be brought about. The fluid may also be designed as an adhesive or bonding agent, which is fluid at least during a processing phase.

In particular if, as explained with respect to the embodiment described above, temporally oscillating forces are transferred to the rotor during joining of the reinforcement sleeve, the additional introduction of a fluid between the reinforcement sleeve and the rotor may simplify the joining process.

According to a further embodiment of the described joining method, the rotor may be cooled before joining.

By means of previously carried out cooling of the rotor to a significantly lower temperature, the rotor may assume significantly smaller dimensions, in particular a reduced cross-section, on account of the associated thermally induced shrinkage. For example, the rotor may be cooled by more than 10° C., preferably more than 20° C., more than 50° C. or even more than 100° C., with respect to a starting temperature or an ambient temperature. In such a cooled state, the reinforcement sleeve may then be joined onto the rotor more easily, i.e. in particular at reduced forces. In addition to a press fit, in this case a shrink fit of the reinforcement sleeve on the rotor may also occur.

In addition to the rotor, the reinforcement sleeve may possibly also be cooled in advance. In this case, optionally use may advantageously be made of the fact that a carbon fiber-reinforced plastics material used for the reinforcement sleeve typically exhibits no thermally induced shrinkage or significantly less than the materials, in particular metal materials, typically used in the rotor.

It is noted that possible features and advantages of embodiments of the invention are described herein sometimes with reference to a method for joining a reinforcement sleeve onto a rotor of an electric motor, and sometimes with reference to a device, which is specially designed to carry out such a method. A person skilled in the art will recognize that the features described for individual embodiments may be transferred, adapted and/or exchanged in an analogous and suitable manner to or in other embodiments, in order to arrive at further embodiments of the invention and possibly synergistic effects.

### BRIEF DESCRIPTION OF THE FIGURES

In the following, advantageous embodiments of the invention are explained in further detail with reference to the accompanying drawings, neither the drawings nor the explanations being intended to be interpreted as limiting the invention in any way.

FIG. 1 is a longitudinal sectional view through a device for joining a reinforcement sleeve onto a rotor of an electric motor according to one embodiment of the present invention.

FIG. 2 is a perspective view of a vacuum cup by way of example for a device according to one embodiment of the present invention.

FIG. 3 is a cross-section through a device according to one embodiment of the present invention.

FIG. 4 is a cross-section through a device according to a further embodiment of the present invention.

The figures are merely schematic and not to scale. The same reference signs in the different drawings denote identical or identically acting features.

### DETAILED DESCRIPTION

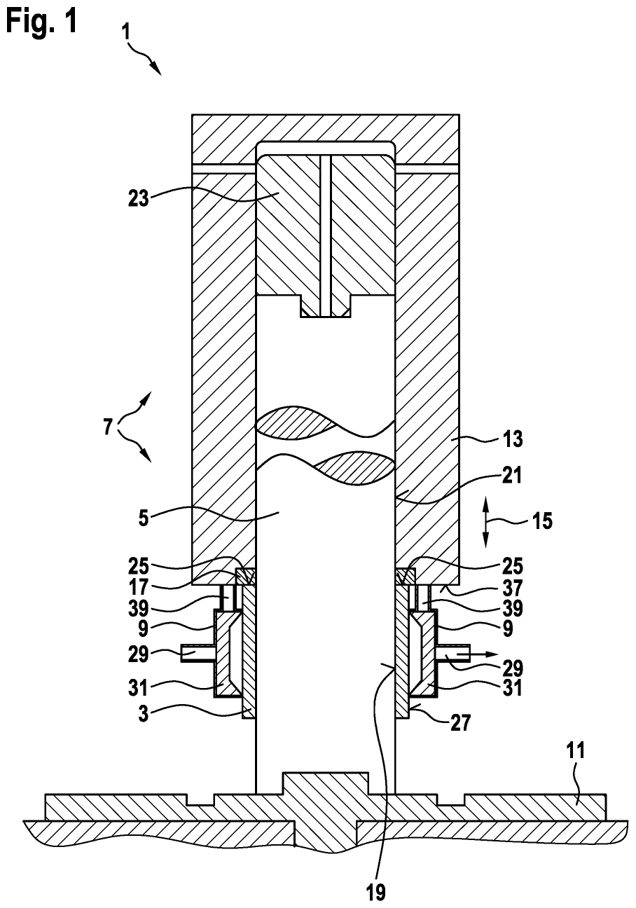

FIG. 1 shows a device 1 according to the invention for joining a reinforcement sleeve 3 onto a rotor 5 of an electric motor. In this case, the reinforcement sleeve 3 is designed so as to be circular cylindrical, has a small wall thickness of for example less than 0.5 mm, and consists of carbon fiber-reinforced plastics material. The reinforcement sleeve 3 is intended to be joined onto the elongate rotor 5 in such a way that it surrounds an outer periphery of the rotor 5, in a press fit. The rotor 5, composed of a plurality of components, is thus bandaged and stabilized by the reinforcement sleeve 3 in the radial direction.

The device 1 comprises a pressing tool 7 and two vacuum cups 9. During a joining process, the pressing tool 7 may press the reinforcement sleeve 3 and the rotor 5 in opposing pressing directions 15 in each case, and thus displace them relative to one another. In the example shown, for this purpose the rotor 5 and a cone 23 arranged thereabove are held vertically on a base plate 11, while a press ram 13 of the pressing tool 7 pushes the reinforcement sleeve 3 downwards over the rotor 5, from above, in a pressing direction 15 in parallel with an axial direction of the rotor 5. For this purpose, the press ram 13 presses, with a lower end face 37, onto a press ring 17. The press ring 17 in turn presses on an upper end face 25 of the reinforcement sleeve 3, and thus pushes the inner peripheral surface 19 thereof successively along an outer peripheral surface 21 of the rotor 5, in the pressing direction 15. In this case, the reinforcement sleeve 3 is subjected to significant mechanical loading at its upper end face 25.

In order that the reinforcement sleeve 3 does not have to be joined over the rotor 5 exclusively by means of the pressure exerted on the upper end face 25 of said reinforcement sleeve via the press ring 17, the device 1 further comprises at least two vacuum cups 9. The vacuum cups 9 are designed to generate a negative pressure between themselves and an outer lateral surface 27 of the reinforcement sleeve 3, and to thereby suction onto the outer lateral surface 27 of the reinforcement sleeve 3 in a reversibly detachable manner. For this purpose, the vacuum cups 9 may be connected to a pump (not shown) by hollow suction lines 29, for example, via which pump the desired vacuum is generated.

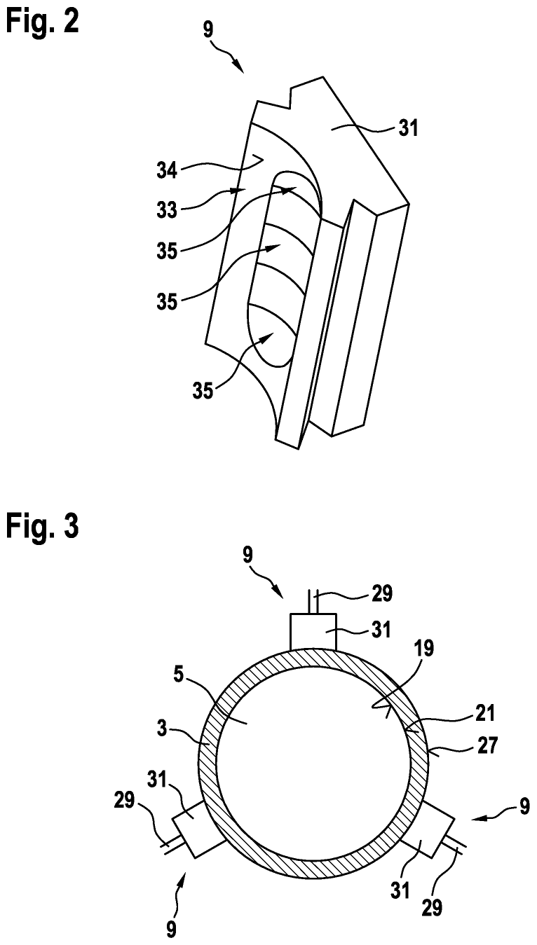

A suction element 31 of a vacuum cup 9 of this kind is shown in FIG. 2. The suction element 31 of the vacuum cup 9 has a contour complementary to the outer lateral surface 27 of the reinforcement sleeve 3, on a side 33 facing the outer lateral surface 27 of the reinforcement sleeve 3. In the example shown, said side 33 is designed as a segment of a cylinder surface, such that the suction element 31 may cling to the cylindrical outer lateral surface 27 of the reinforcement sleeve in a complementary manner. At least on the side 33 facing the reinforcement sleeve 3, the suction element 31 may consist of a flexible, for example rubbery, material. In a center of said side 33, the suction element 31 comprises a plurality of suction intakes 35, out of which air may be suctioned for example via a suction line 29 connected thereto, and thus the desired vacuum between the suction element 31 of the vacuum cup 9 and the reinforcement sleeve 3 may be generated. Furthermore, the side 33 facing the reinforcement sleeve 3 may comprise a friction-enhancing surface, for example in that said surface is roughened or provided with a macroscopic texture.

In order to then assist the device 1 when joining the reinforcement sleeve 3 onto the rotor 5, the pressing tool 7 and/or the vacuum cups 9 are designed such that, during the joining process, forces acting in the pressing direction 15 are transferred from the vacuum cups 9 to the reinforcement sleeve 3. In the example shown in FIG. 1, for this purpose the two suction elements 31 of the vacuum cups 9 are supported on the lower end face 37 of the press ram 13 by means of support structures 39. Accordingly, the press ram 13 presses not only the press ring 17, and via said ring the upper end face 25 of the reinforcement sleeve 3, downwards in the pressing direction 15, but rather also the two vacuum cups 9 and via these the outer lateral surface 27 of the reinforcement sleeve 3.

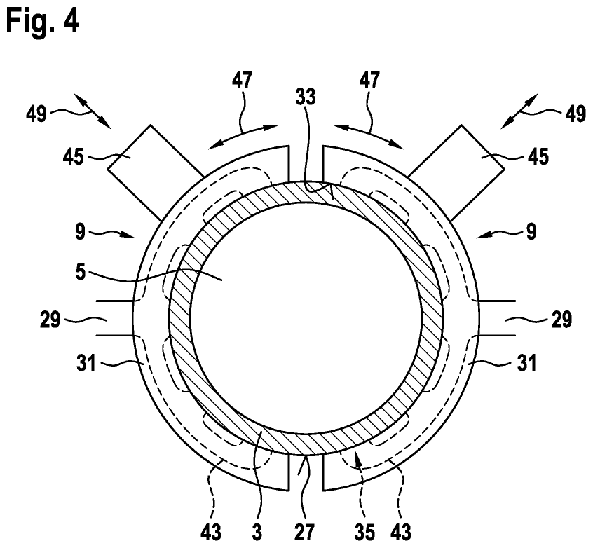

FIGS. 3 and 4 are cross-sectional views of two possible embodiments of how the vacuum cups 9 may be formed, may be arranged on the reinforcement sleeve 3, and may interact with the reinforcement sleeve 3.

In the embodiment shown in FIG. 3, the suction elements 31 of the vacuum cups 9 are designed so as to be relatively small and box-like. Accordingly, the vacuum cups 9 contact the outer lateral surface 27 of the reinforcement sleeve 3 merely in a quasi point-wise manner or on relatively small surfaces with respect to an overall surface of the lateral surface 27. In the example, three vacuum cups 9 are provided, which are arranged in an equidistant manner along the periphery of the lateral surface 27.

In the embodiment shown in FIG. 4, the suction elements 31 are designed having an annular segment-shaped contour. Only two vacuum cups 9 are provided. In this case, each of the two suction elements 31 clings to the cylindrical outer lateral surface 27 of the reinforcement sleeve 3, by means of the side 33 of said suction element facing the reinforcement sleeve 3, which side approximately forms half a cylinder surface. In this case, channels 43 (shown in dashed lines) may be provided in the suction element 31, via which channels a plurality of suction intakes 35 are connected to the respective suction line 29, such that the suction element 31 may adhere to the reinforcement sleeve 3 by means of generation of a negative pressure.

As is indicated merely in a highly schematic manner in FIG. 4, the device 1 may additionally comprise an oscillation generator 45. Said oscillation generator 45 may cause the vacuum cups 9 to be subjected to oscillating forces, and to transfer these in turn to the reinforcement sleeve 3. The oscillating forces may act in different directions. By way of example, forces are indicated in FIG. 4 which press in the peripheral direction 47 and/or in the radial direction 49, it also being possible for forces acting in the axial direction (i.e. orthogonally to the image plane in FIG. 4) to be transferred from the oscillation generator 45 to the respective suction elements 31 of the vacuum cups 9. The joining process may be assisted by virtue of the oscillating forces.

It is noted in addition that terms such as “comprising” or “having” do not exclude any other elements or steps, and terms such as “a” or “one” do not exclude a plurality. It is furthermore noted that features or steps that have been described with reference to one of the above embodiments may also be used in combination with other features or steps of other embodiments described above. Reference signs in the claims are not to be considered limiting.

### LIST OF REFERENCE SIGNS

1 device
3 reinforcement sleeve
5 rotor
7 pressing tool
9 vacuum cups
11 base plate
13 press ram
15 pressing direction
17 press ring
19 inner peripheral surface of the reinforcement sleeve
21 outer peripheral surface of the rotor
23 cone
25 upper end face of the reinforcement sleeve
27 outer lateral surface of the reinforcement sleeve
29 suction line
31 suction element
33 side of the vacuum cup facing the reinforcement sleeve
34 friction-enhancing surface
35 suction intakes
37 lower end face of the press ram
39 support structure
43 channel
45 oscillation generator
47 peripheral direction
49 radial direction

1-15. (canceled)

16. A method for joining a reinforcement sleeve onto a rotor of an electric motor, the method comprises:
providing the reinforcement sleeve and the rotor, wherein the reinforcement sleeve has a cylindrical inner periphery which is undersized with respect to a cylindrical outer periphery of the rotor;
attaching at least two vacuum cups onto an outer lateral surface of the reinforcement sleeve, such that the vacuum cups adhere to the outer lateral surface of the reinforcement sleeve in a reversibly detachable manner on account of a vacuum generated between the vacuum cup and the outer lateral surface; and
joining the reinforcement sleeve onto the rotor, in that the rotor is pressed into the reinforcement sleeve in a pressing direction, wherein forces acting in the pressing direction are transferred from the vacuum cups to the reinforcement sleeve.

17. The method according to claim 16, wherein the reinforcement sleeve has a wall thickness of less than 2 mm.

18. The method according to claim 16, wherein the reinforcement sleeve is formed using fiber-reinforced, in particular carbon fiber-reinforced or glass fiber-reinforced, plastics material.

19. The method according to claim 16, wherein the vacuum cups have a contour complementary to the outer lateral surface of the reinforcement sleeve, on a side facing the outer lateral surface of the reinforcement sleeve.

20. The method according to claim 16, wherein the vacuum cups have an annular segment-shaped contour on a side facing the outer lateral surface of the reinforcement sleeve.

21. The method according to claim 16, wherein the vacuum cups have a friction-enhancing surface on a side facing the reinforcement sleeve.

22. The method according to claim 16, wherein forces transferred from the vacuum cups to the reinforcement sleeve are generated in a temporally oscillating manner.

23. The method according to claim 16, wherein a liquid is introduced between an outer peripheral surface of the rotor and an inner peripheral surface of the reinforcement sleeve.

24. The method according to claim 16, wherein the rotor is cooled prior to joining.

25. A device for joining a reinforcement sleeve onto a rotor of an electric motor, wherein the device is designed to carry out the method according to claim 16.

26. A device, comprising:
a pressing tool, which is designed to displace the rotor and the reinforcement sleeve relative to one another, in an opposing pressing direction, during a joining process in which the reinforcement sleeve is joined onto the rotor,
at least two vacuum cups, which are in each case designed to generate a vacuum between the vacuum cup and an outer lateral surface of the reinforcement sleeve and to thereby cause the vacuum cup to adhere to the outer lateral surface of the reinforcement sleeve in a reversibly detachable manner,
wherein the pressing tool and/or the vacuum cups are designed such that, during the joining process, forces acting in the pressing direction are transferred from the vacuum cups to the reinforcement sleeve.

27. The device according to claim 26, wherein the vacuum cups have a contour complementary to the outer lateral surface of the reinforcement sleeve, on a side facing the outer lateral surface of the reinforcement sleeve.

28. The device according to claim 26, wherein the vacuum cups have an annular segment-shaped contour on a side facing the outer lateral surface of the reinforcement sleeve.

29. The device according to claim 26, wherein the vacuum cups have a friction-enhancing surface on a side facing the reinforcement sleeve.

30. The device according to claim 26, further comprising an oscillation generator which is designed to generate forces, transferred from the vacuum

31. The device according to claim 26, wherein the device is designed to carry out the method according to claim 16.
